(19) United States
(12) Patent Application Publication
(10) Pub. No.: US 2010/0170089 A1
(43) Pub. Date: Jul. 8, 2010

(54) AUTOMATED WIRING APPARATUS AND METHOD

(75) Inventors: Frank Gerwin Kaufhold, Suffolk (GB); Ian Albert Edward Swann, Suffolk (GB); John Richard Willoughby, Essex (GB); George William Francis, Suffolk (GB)

Correspondence Address: MCGARRY BAIR PC, 32 Market Ave. SW, SUITE 500, GRAND RAPIDS, MI, 49503, US

(73) Assignee: UNITED TECHNOLOGISTS EUROPE LIMITED, Suffolk (GB)

(21) Appl. No.: 12/523,142

(22) PCT Filed: Mar. 19, 2008
(86) PCT No.: PCT/GB2008/050203

§ 371 Date: Jul. 14, 2009

(30) Foreign Application Priority Data
Mar. 20, 2007 (GB) 0705304.4

(51) Int. Cl. H01R 43/00

(52) U.S. Cl. 29/857; 29/748

(57) ABSTRACT

Automated wiring apparatus (20) is provided for the insertion and extraction of a length of wire (35) into a selected connector (74) on a connector block (22, 23). The apparatus (20) comprises a tool head (24) provide with one or more wire manipulation tools (30, 36, 38, 39, 49, 57) associated with effecting insertion and extraction of the wire (35). A supporting framework (25, 26) is mounted adjacent one or more connector blocks (22, 23) so as to define an operational plane for the tool head (24). The operational plane has mutually perpendicular X and Y axes, and is disposed parallel to and spaced from the connector blocks (22, 23). Positioning control means (41) are provided to locate the tool head (24) at any selected X1Y co-ordinates in the operational plane defined by the supporting framework (25, 26), said selected X1Y co-ordinates corresponding to a selected connector (74) on the connector blocks (22, 23), whilst wiring control means (54, 55, 56, 65, 72) are provided to actuate the wiring (30, 36, 38, 39, 49, 57) tools on the tool head (24), thereby to effect insertion or extraction of a wire (35) into a selected connector (74), as required.

This invention relates to an apparatus and method for inserting a wire into a selected connector on a connector block, and extracting a wire from a connector. In particular, the invention relates to fully automated apparatus for performing these operations, and to a method of performing these operations utilising such automated apparatus.

The apparatus and method of the present invention have been developed for use in the wiring of so-called jumper connections in telecommunications network distribution frames using twisted pair cabling, and so will be described herein with particular emphasis on this application. It is however envisaged that the apparatus and method of the present invention may be adapted for use in other technologies.

Telecommunications network distribution frames typically comprise paired parallel banks of connector blocks, often referred to as insulation displacement connector (IDC) blocks. IDC blocks comprise an array of individual connectors, each adapted to receive a length of insulated wire conductor (IWC) cabling, and to form an electrical connection therewith by displacing the insulation on the cabling, usually by means of a connector blade located within each IDC.

One member of each pair of connector blocks is connected to subscribers' telephone lines, whilst the other member of the pair is connected to active telephone exchange equipment enabling, for example, internet connection. Connection of a particular subscriber to a particular service (e.g. broadband internet) is effected by wiring a selected pair of adjacent connectors on the subscriber block to a selected pair of adjacent connectors on the active equipment block. This interconnection of the respective connector blocks, commonly referred to as a jumper connection, is typically carried out using twisted pair cabling.

Twisted pair cabling is a form of electrical wiring comprising two individual insulated wire conductors, which are wound together primarily to reduce interference, and also to increase the strength of the wire. However, when making jumper connections in telecommunications network distribution frames, portions at each end of the twisted pair cable must be unwound to form lengths of parallel, separated insulated wire conductors.

A typical telecommunications network distribution frame can comprise many thousands of individual connectors, and hence many thousands of individual connections. These connections require constant maintenance, removal, and re-wiring, for example as subscribers join or leave a particular service, or require connection to additional services. Conventionally, the operations of forming and removing jumper connections have been performed manually using hand-operated tools, and as a consequence the process tends to be slow, labour intensive and susceptible to error. The introduction of automated or robotic wiring systems is therefore highly desirable.

An automated apparatus and method for separating a length of twisted pair cable into its individual insulated wire conductors, ready for insertion into a pair of adjacent connectors, is described in the applicant's International Patent Application No. PCT/GB2008/050079. A modified insulation displacement connector block for use with automated wiring apparatus is described in the applicant's International Patent Application No. PCT/GB2008/050136. A mechanism and method for feeding a length of twisted pair cable to an automated wiring tool is described in the applicant's International Patent Application No. PCT/GB2008/050153. The automated wiring apparatus and method of the present invention is intended for use with, and incorporating the features of, all of these apparatus and methods.

The present invention seeks to provide an automated wiring apparatus and method for making and breaking jumper connections in a telecommunications network distribution frame. The present invention further seeks to provide automated wiring apparatus for permanent installation on a telecommunications network distribution frame, for remote operation.

According to a first aspect of the present invention there is provided automated wiring apparatus for insertion and/or extraction of a length of wire into a selected connector on a connector block, said apparatus comprising:
a tool head comprising one or more wire manipulation tools associated with effecting said insertion and extraction;
a supporting framework adapted for mounting adjacent a connector block;
positioning control means adapted to locate the tool head at any selected position on the supporting framework, each said selected position corresponding to a selected connector on the connector block; and
wiring control means adapted to actuate said one or more wiring tools on the tool head, thereby to effect insertion or extraction of a wire into a selected connector, as required.

In a preferred embodiment of the first aspect of the present invention, the supporting framework defines an operational plane for the tool head, said operational plane having mutually perpendicular X and Y axes, and being disposed parallel to and spaced from said connector block when said framework is mounted adjacent thereto; and the positioning control means is adapted to located the tool head at any selected X,Y co-ordinates in the operational plane, each said selected X,Y co-ordinates corresponding to a selected connector on the connector block.

In alternative embodiments, the supporting framework may be curved, or even circular, in at least one direction, for mounting adjacent a curved or circular bank of connector blocks. Such alternative embodiments will not be described herein in detail, but references to the operational plane and the X and Y axes thereof with respect to the preferred embodiment should be construed accordingly so as to encompass such alternative curved embodiments in addition to the preferred planar embodiment.

In order to achieve the required range of movement of the tool head in the operational plane, the supporting framework preferably comprises a fixed track arranged parallel to one of the X or Y axes of the operational plane, and a moveable track arranged parallel to the other of the X or Y axes of the operational plane. In this arrangement, the moveable track is mounted for movement along the fixed track, whilst the tool head is mounted for movement along the moveable track.

Most preferably, the fixed track is arranged parallel to the vertical Y axis of the operational plane, and the moveable track is arranged parallel to the horizontal X axis of the operational plane. The moveable track is thus mounted for movement along the fixed track, parallel to the Y axis of the operational plane, whilst the tool head is mounted for movement along the moveable track, parallel to the X axis of the operational plane. It should be appreciated however, that the opposite arrangement—i.e. the fixed track being arranged parallel to the X axis and the moveable track being arranged parallel to the Y axis—may alternatively be utilised. It should further be appreciated that, for the alternative curved embodiments described above, at least one of the fixed track and the moveable track may itself be curved; or at least one of the fixed track and the moveable track may be dispensed with, and the tool head may instead be mounted for rotary motion.

The positioning control means preferably comprises one or more position sensors provided on the tool head and adapted to determine the location of the tool head in the operational plane, and tool head drive means adapted to drive the tool head to a selected location in the operational plane. Most preferably, said one or more position sensors are adapted to determine the location of the tool head in the operational plane with reference to X and Y co-ordinates corresponding to individual connectors on the connector block. The position sensors may desirably be further adapted for the taking of reference measurements, thereby to calibrate the positioning control means.

The movement of the tool head along the moveable track, and the movement of the moveable track along the fixed track, are each preferably controlled by servo actuators operated by the positioning control means. The positioning control means is preferably adapted to respond to remote control, in combination with input from said one or more position sensors, and pre-programmed logic. The means for driving the tool head along the moveable track and the moveable track along the fixed track can be any controllable system capable of accurate reversible drive, such as toothed belts and pulleys, rack and pinion, ball screw, or any combination of these.

The one or more wire manipulation tools provided on the tool head preferably include a wire insertion and extraction tool, adapted to effect insertion and extraction of the wire. Most preferably, the wire insertion and extraction tool is adapted to effect insertion and extraction of the wire in a direction parallel to a Z axis, being perpendicular to each of said X and Y axes and the operational plane of the tool head. The wire insertion and extraction tool is preferably adapted to effect insertion and extraction by performing a short stroke in a direction parallel to the Z axis, under servo control.

The one or more wire manipulation tools provided on the tool head preferably further include one or more of the following:
one or more wire bending tools adapted to bend each wire into a vertical orientation in preparation for insertion into a selected connector;
a wire gripping tool adapted to grip each wire in preparation for, and during, insertion into a selected connector, and subsequent extraction therefrom;
an insertion blade adapted for forced insertion of each wire into a selected connector, said insertion blade preferably further comprising a force limiting system; and/or
a cutting mechanism to cut excess wire subsequent to insertion of each wire into its selected connector.

Most preferably the one or more wire manipulation tools provided on the tool head include each of the above described tools.

The automated wiring apparatus of the first aspect of the present invention is preferably adapted for insertion and extraction of separated individual insulated wire conductors of a length of twisted pair cable into a selected pair of adjacent connectors on an insulation displacement connector block. The one or more wire manipulation tools provided on the tool head therefore preferably further include a wire separation tool for separating a length of twisted pair cable into its constituent individual insulated wire conductors.

A preferred form of wire separation tool is described in the applicant's International Patent Application No. PCT/GB2008/050079, and comprises: a separator adapted for insertion between the individual insulated wire conductors constituting the twisted pair cable; and cable drive means adapted to displace the length of twisted pair cable relative to the inserted separator in a direction co-incident with the axis of the twisted pair cable. The displacement of the twisted pair cable relative to the separator, causes plastic deformation of the individual insulated wire conductors thus forming a length of cable comprising a pair of substantially parallel separated individual insulated wire conductors.

The insulating sheaths of the individual insulated wire conductors of a length of twisted pair cable are generally colour-coded—usually white and red—to indicate the correct wire, for example, to be connected to the positive and negative terminals of a circuit. In the formation of jumper connections, it is crucial that the correct orientation of the individual conductors of the twisted pair cable is maintained at each end of the jumper connection—i.e. on both the subscriber line connector block and the exchange equipment connector block. In order to ensure the correct orientation of the individual insulated wire conductors in the formation of jumper connections, the tool head preferably further comprises a sensor, preferably a line scan camera, adapted to detect the colour orientation of the individual insulated wire conductors adjacent the separator. A length of separated parallel conductors with the white and red coloured wires in the required left-to-right orientation, can thus be generated.

The tool head is preferably further adapted to effect insertion of both separated individual insulated wire conductors of a length of twisted pair cable into adjacent connectors on an insulation displacement connector block, in a single operation; and to effect extraction of both separated individual insulated wire conductors of a length of twisted pair cable from adjacent connectors on an insulation displacement connector block, in a single operation.

In order efficiently to achieve the automated insertion and extraction of separated individual insulated wire conductors of a length of twisted pair cable into selected adjacent connectors on a connector block, it has been found that certain modifications to the design of standard insulation displacement connector blocks is desirable. A preferred form of modified insulation displacement connector block is described in the applicant's International Patent Application No. PCT/GB2008/050136, and comprises: an array of insulation displacement connectors adapted to receive an insulated wire conductor; and guide means spaced relative to said connector array so as to define a gap therebetween. The guide means is adapted for aligning each wire conductor with a selected connector, and further adapted to receive a length of each wire conductor extending from its selected connector to a corresponding location on the guide means, such that the length of insulated wire conductor bridges the gap. A length of insulated wire conductor is thus presented to the tool head for subsequent removal, when required.

The scope of the present invention includes automated wiring apparatus as hereinbefore described, comprising such a modified insulation displacement connector block as an element thereof.

The automated wiring apparatus of the first aspect of the present invention preferably further comprises a feeding mechanism for feeding a length of wire to the tool head. A preferred form of feeding mechanism for feeding a length of twisted pair cable to the tool head is described in the applicant's International Patent Application No. PCT/GB2008/050153, and comprises: a capstan having a substantially circular periphery; a continuous belt supported so that a portion thereof embraces an arc of the capstan periphery; a path defined between the capstan and the continuous belt and adapted to receive said length of twisted pair cable; and drive means for effecting rotation of the capstan. The path must be sufficiently long such that at least two nodes (twists) of the length of twisted pair cable are accommodated therein. This ensures that rotation of the capstan drives the twisted pair cable along the path, without causing rotation of the cable about its axis.

The drive means for effecting rotation of the capstan is preferably under servo control and adapted to effect precise forward and backward motion of the twisted pair cable.

The automated wiring apparatus preferably further comprises a replaceable reel or cassette of twisted pair cable mounted within the apparatus, said feeding mechanism being adapted to draw lengths of twisted pair cable from said replaceable reel or cassette as and when required.

The replaceable reel or cassette is preferably provided with a rewind spring and slipping mechanism to maintain tension in the twisted pair cable as it is supplied to the feeding mechanism. The twisted pair cable is thus withdrawn from the reel or cassette against a light resistance. The rewind mechanism may comprise a constant force helical coil spring and clutch, or a torque limiting electric motor.

As stated hereinbefore, the present invention seeks to provide automated wiring apparatus for permanent installation on a telecommunications network distribution frame. Therefore, the automated wiring apparatus of the present invention is preferably adapted for installation in a telephone network distribution frame, and further adapted to be operated by remote control. The present invention thus removes the need for the physical presence of a service engineer at a telephone network distribution frame in order to make and break jumper connections.

The scope of the present invention accordingly further includes a telephone network distribution frame, having automated wiring apparatus as hereinbefore described installed therein.

According to a second aspect of the present invention there is provided an automated wiring method for insertion of a length of wire into a selected connector on a connector block, said method comprising:
positioning a wiring tool head at a selected location on a supporting framework mounted adjacent a connector block, said selected location corresponding to a selected connector on said connector block; and
actuating the wiring tool head so as to effect insertion of a portion of a wire into said selected connector.

A preferred embodiment of automated wiring method according to the second aspect of the present invention comprises positioning the tool head at a pair of selected X,Y co-ordinates in an operational plane defined by the supporting framework, said operational plane being parallel to and spaced from said connector block, each said pair of X,Y co-ordinates corresponding to a selected connector on said connector block.

Preferably, the length of wire is a length of twisted pair cable, separated into a pair of substantially parallel individual insulated wire conductors; and the wiring tool head is positioned and actuated so as to effect insertion of a portion of said separated parallel conductors into a selected pair of adjacent connectors on the connector block.

The automated wiring method according to the second aspect of the present invention is thus preferably adapted for effecting a jumper connection between a first selected pair of adjacent connectors located on a first connector block—for example, the subscriber line connector block in a telephone network distribution frame—and a second selected pair of adjacent connectors located on a second parallel connector block—for example, the exchange equipment connector block in the same said telephone network distribution frame.

The automated wiring method thus preferably comprises:
positioning a wiring tool head at a first pair of selected X,Y co-ordinates in an operational plane parallel to and spaced from first and second connector blocks arranged parallel to one another, said first pair of X,Y co-ordinates corresponding to a first selected pair of adjacent connectors on said first connector block;
actuating the wiring tool head so as to effect insertion of a first portion of said length of separated parallel conductors into said first selected pair of adjacent connectors, thereby to form a first end of a jumper connection;
positioning said wiring tool head at a second pair of selected X,Y co-ordinates in said operational plane, said second pair of selected X,Y co-ordinates corresponding to a second selected pair of adjacent connectors on said second connector block; and
actuating the wiring tool head so as to effect insertion of a second portion of the same length of separated parallel conductors into said second selected pair of adjacent connectors, thereby to form a second end of said jumper connection.

The or each step of positioning the tool head at selected X,Y co-ordinates preferably utilises one or more position sensors to determine the location of the tool head in the operational plane, and optionally, to calibrate positioning control means adapted to locate the tool head at selected X,Y co-ordinates in the operational plane.

The or each step of actuating the wiring tool head preferably effects insertion of each wire into its selected connector in a direction parallel to a Z axis, being perpendicular to each of said X and Y axes, and perpendicular to the operational plane.

The automated wiring method according to the second aspect of the present invention preferably further comprises one or more of the following steps:
bending each said portion of wire into a vertical orientation in preparation for insertion into its selected connector;
gripping each said portion of wire in preparation for, and during, insertion into its selected connector; and/or
cutting excess wire subsequent to insertion of each wire into its selected connector.

Most preferably, the automated wiring method comprises each of the above steps, and may further comprise a step of extracting a previously inserted wire from a selected connector.

Where the automated wiring method is adapted for insertion of a length of twisted pair cable into a selected pair of adjacent connectors on a connector block, the method preferably further comprises one or more steps of separating said length of twisted pair cable into its constituent individual insulated wire conductors.

The automated wiring method preferably further comprises one or more steps of feeding a length of wire to the wiring tool head.

The scope of the present invention extends to include any embodiment of automated wiring method as hereinbefore described, utilising any embodiment of automated wiring apparatus as hereinbefore described.

In order that the present invention may be better understood, a preferred embodiment thereof will now be described in detail, though only by way of example, with reference to the accompanying drawings, in which:

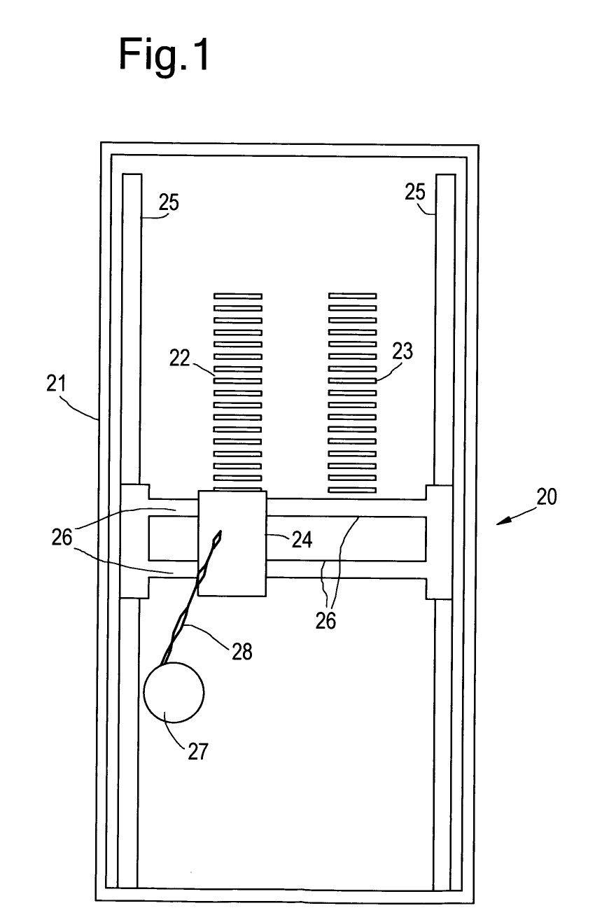

FIG. 1 is a diagrammatic illustration showing a preferred embodiment of automated wiring apparatus according to a first aspect of the preset invention, when installed in a telecommunications network distribution frame cabinet;

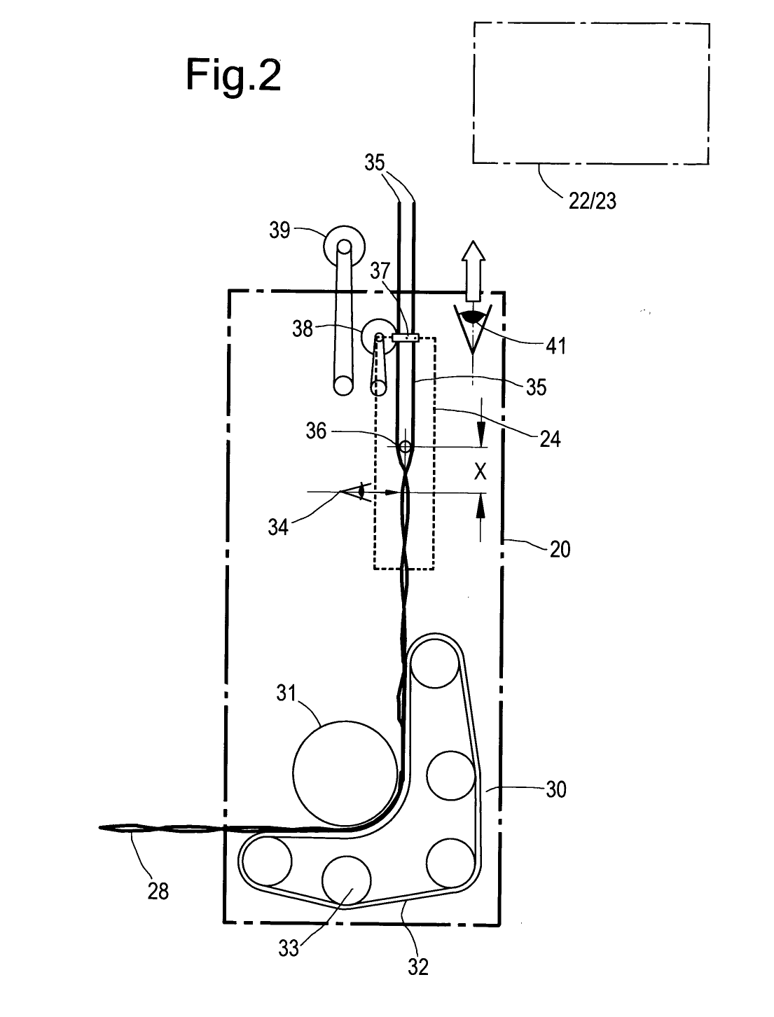

FIG. 2 is a diagrammatic illustration showing the wire manipulation tools provided within the tool head of the automated wiring apparatus of FIG. 1;

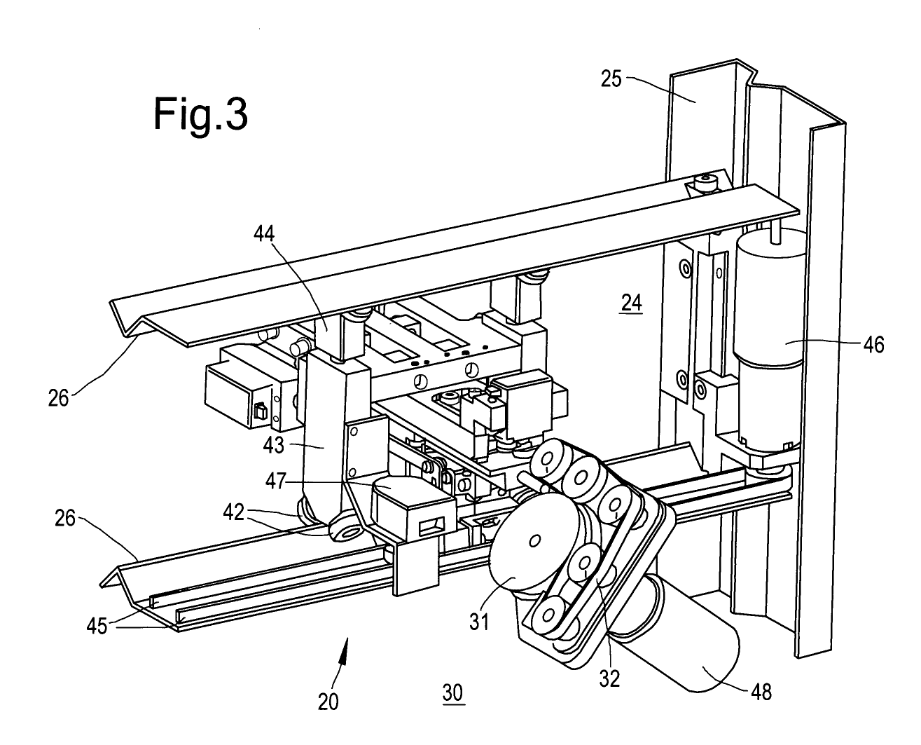

FIG. 3 is a perspective front view of the automated wiring apparatus of FIGS. 1 and 2;

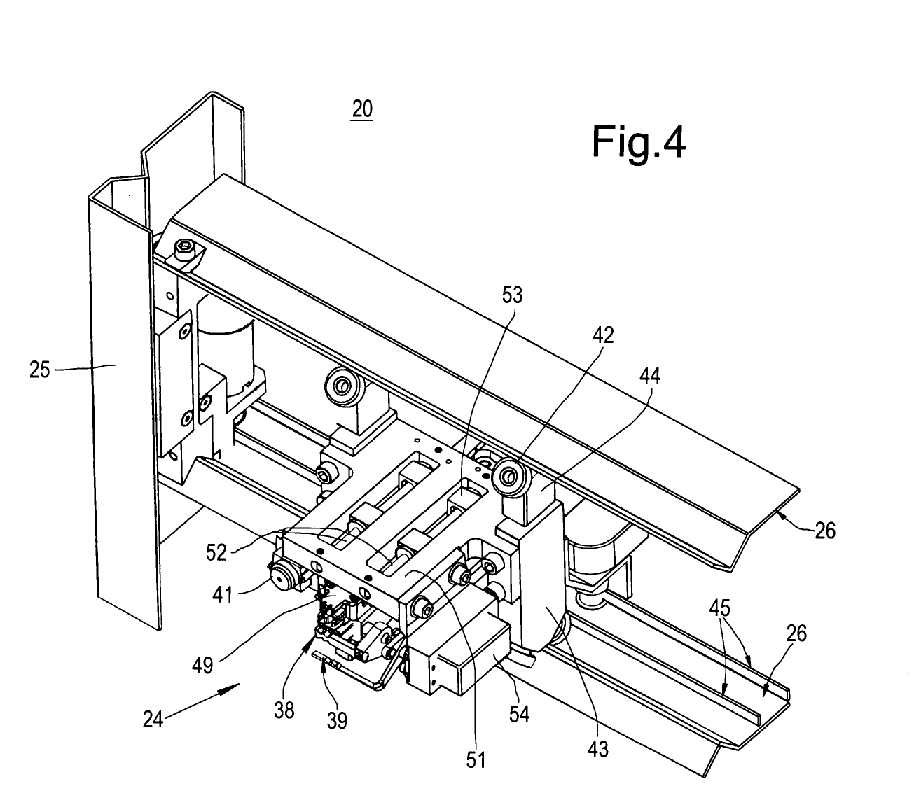

FIG. 4 is a perspective rear view of automated wiring apparatus of FIGS. 1 to 3, with certain components omitted for clarity;

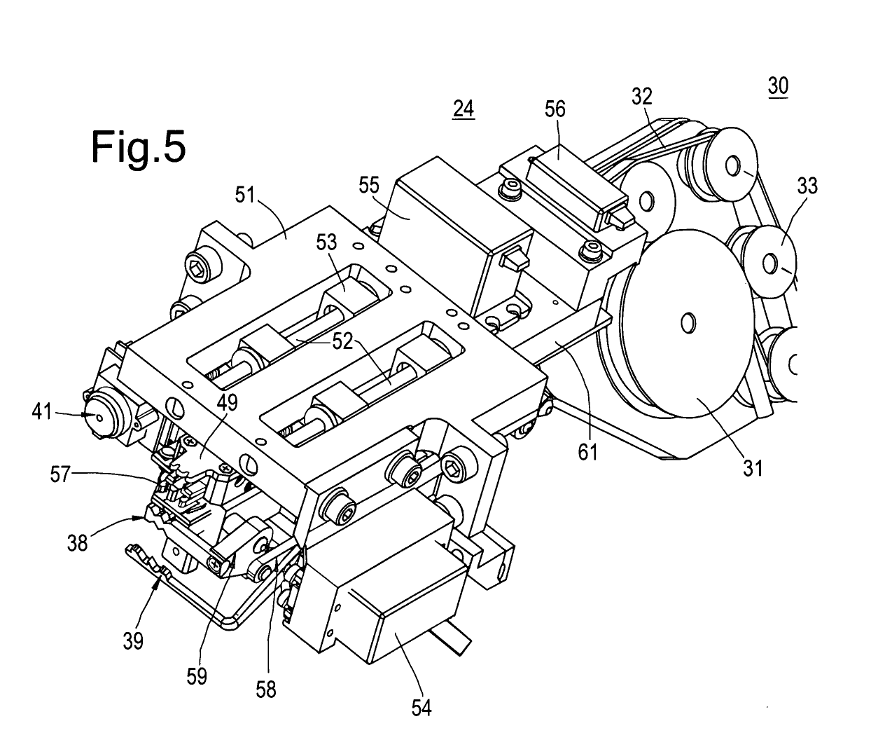

FIG. 5 is a perspective view from above of the tool head of the automated wiring apparatus of FIGS. 1 to 4, with certain components omitted for clarity;

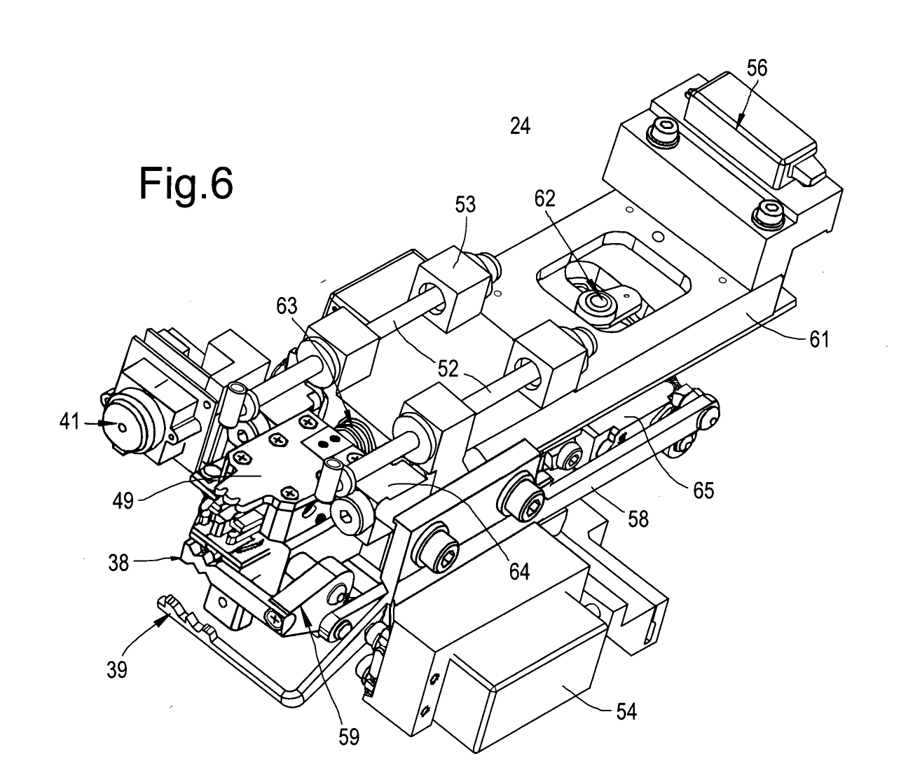

FIG. 6 is a further perspective view from above of the tool head of FIG. 5, with certain components omitted for clarity;

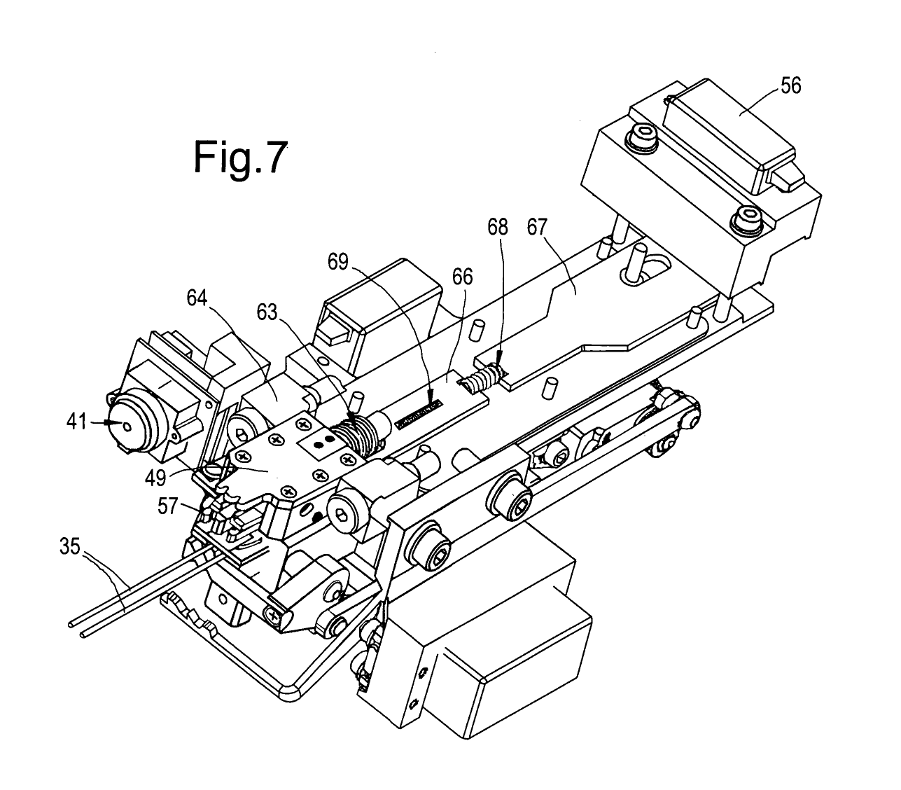

FIG. 7 is a further perspective view from above of the tool head of FIGS. 5 and 6, with certain components omitted for clarity;

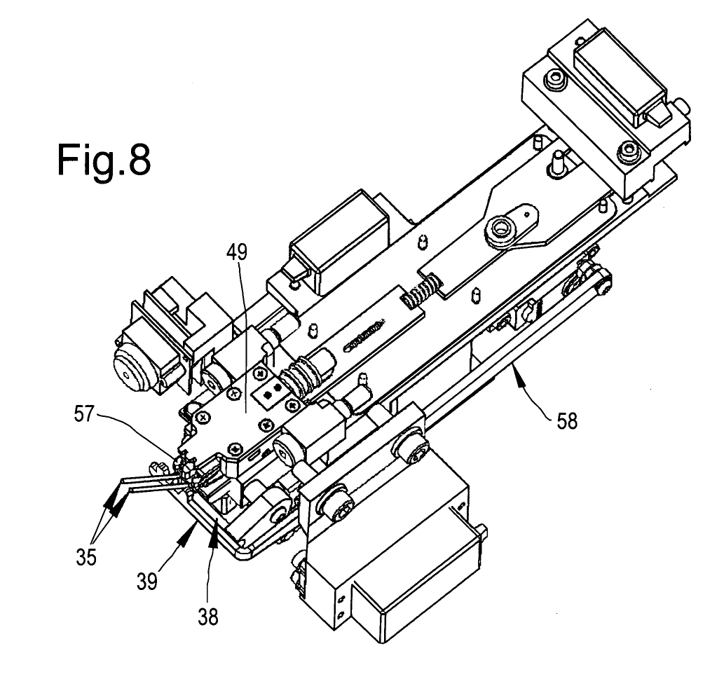

FIG. 8 is a further perspective view from above of the tool head of FIGS. 5 to 7, with certain components omitted for clarity;

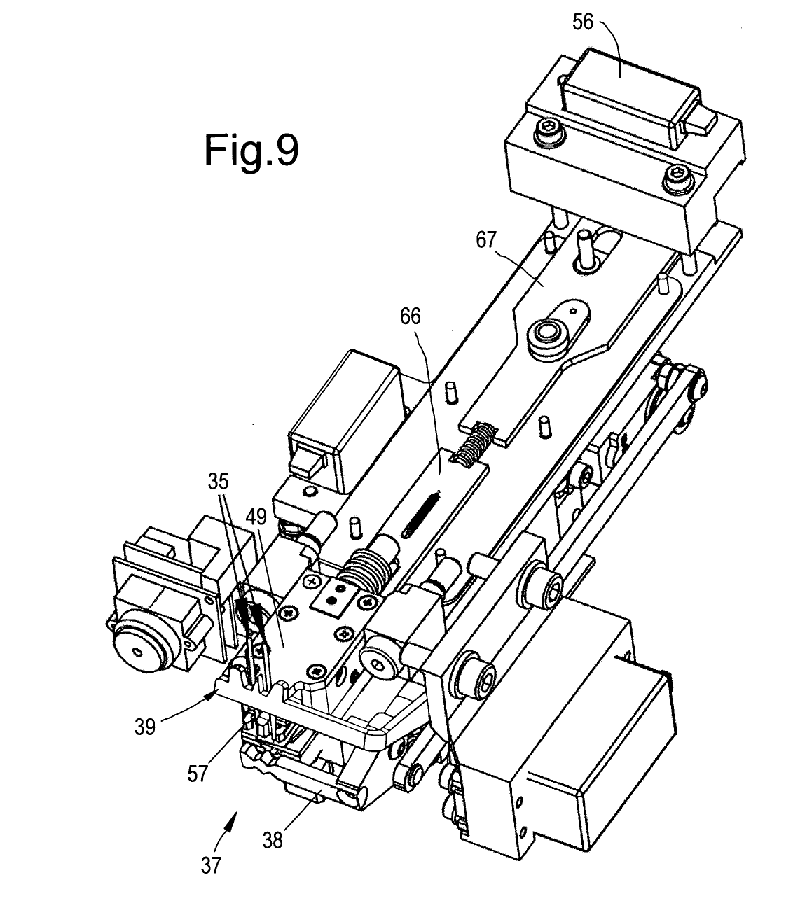

FIG. 9 is a further perspective view from above of the tool head of FIGS. 5 to 8, with certain components omitted for clarity;

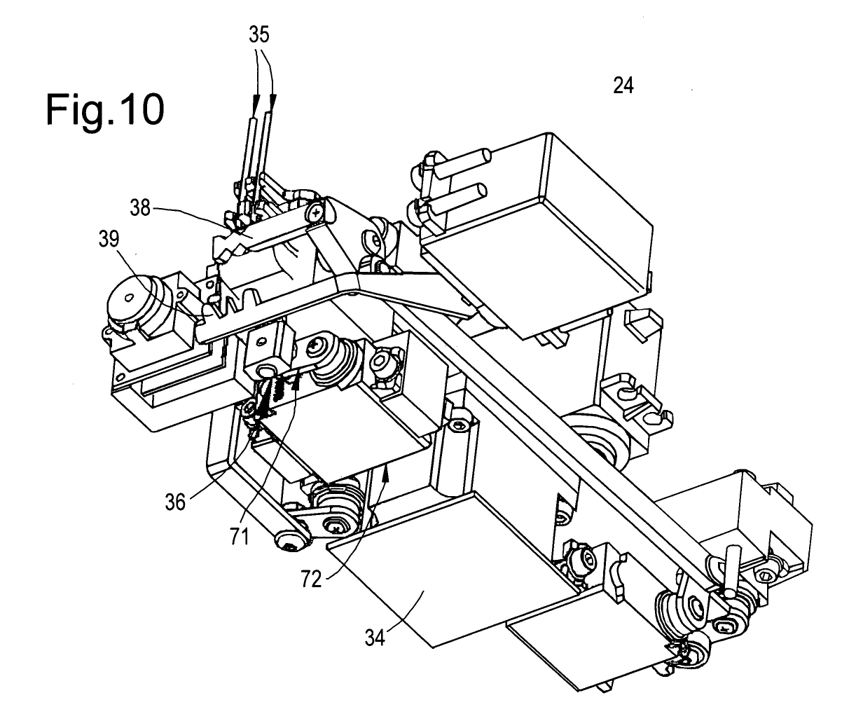

FIG. 10 is a perspective view from below of the tool head of FIGS. 5 to 9, with certain components omitted for clarity; and

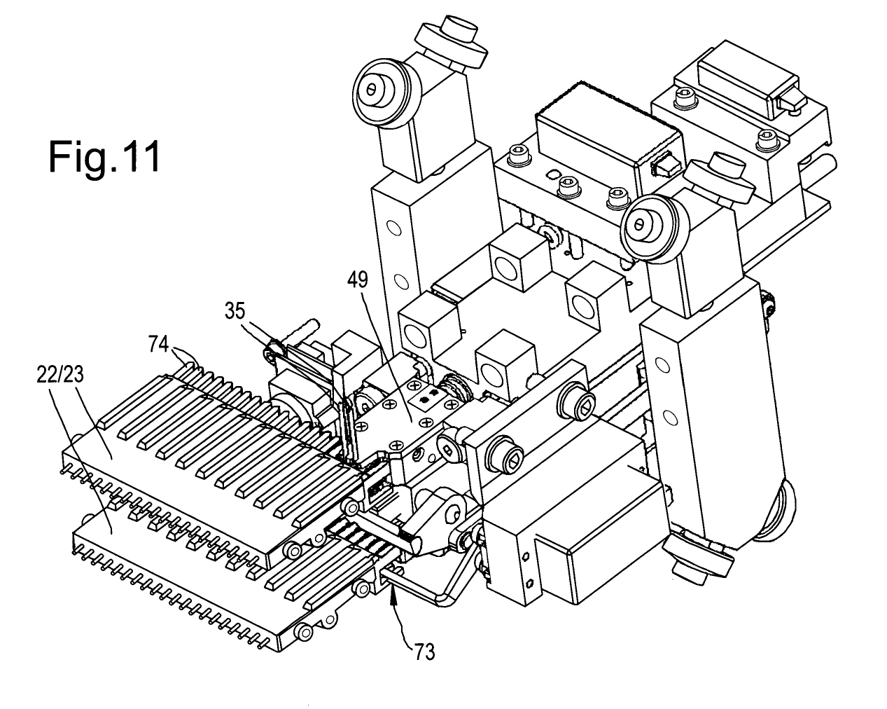

FIG. 11 is a perspective view from above showing the tool head of FIGS. 5 to 10 arranged adjacent a modified insulation displacement connector block, for the wiring thereof.

Referring first to FIG. 1, there is shown a preferred embodiment of automated wiring apparatus, generally indicated 20 installed in a telecommunications network distribution frame cabinet 21 having a first bank of insulation displacement connector (IDC) blocks 22 connected to subscribers' lines (not shown) and a second bank of like IDC blocks 23 connected to telecommunications exchange equipment (not shown).

The automated wiring apparatus 20 comprises a tool head 24, on which are provided a range of wire manipulation tools, as will be described below with reference to FIGS. 2 to 11. The tool head 24 is mounted for movement in the horizontal (X) and vertical (Y) directions across the face of the parallel banks of IDC blocks 22, 23, by means of a pair of opposed vertical guide rails forming a fixed track 25 and a pair of opposed horizontal guide rails forming a moveable track 26. The tool head 24 is mounted for movement in the X direction along the moveable track 26, which is in turn mounted for movement in the Y direction along the fixed track 25. The tool head 24 can thus be located at any set of X,Y co-ordinates in an operational plane defined between the opposed rails of the fixed track 25, each said set of X,Y co-ordinates corresponding to a selected connector, or selected pair of adjacent connectors, on the first and second banks of IDC blocks 22, 23.

A replaceable reel 27 of twisted pair cable 28 is provided within the distribution frame cabinet 21, and is arranged to supply twisted pair cable 28 to the tool head 24 for further processing within the head 24 by the wire manipulation tools, as will be described below with reference to FIGS. 2 to 11. The reel 27 is provided with a long travel constant torque spring (not shown) to maintain tension in the twisted pair cable 28 at a reasonably constant level.

Referring now to FIG. 2, there is shown a diagrammatic illustration of the wire manipulation tools provide within the tool head 24. As can be seen, the twisted pair cable 28 is arranged to be fed into the tool head 24 by a feeding mechanism, generally indicated 30, as described in the applicant's International Patent Application No. PCT/GB2008/050153. The feeding mechanism 30 comprises a driven capstan 31 and a continuous rubber belt 32 supported on rollers 33 such that a portion of the belt 32 embraces the periphery of the capstan 31. The twisted pair cable 28 is embraced on either side thereof by the opposed surfaces of the capstan 31 and the belt 32, such that driven rotation of the capstan 31 draws twisted pair cable 28 from the reel 27 and delivers it to the tool head 24. The feeding mechanism 30 is configured such that the twisted pair cable 28 is engaged between the capstan 31 and the belt 32 over a length of the cable 28 covering at least two nodes (twists) of the helical cable 28.

A line scan camera 34 is positioned to scan the twisted pair cable 28 as it emerges from the feeding mechanism 30. The control means (not shown) operating the automated wiring apparatus 20 is adapted to detect the colour orientation (white/red or red/white) of the individual insulated wire conductors 35 of the twisted pair cable 28 and to select a portion of the cable 28 corresponding to a pre-determined orientation specified for a particular jumper connection.

A separator pin 36, forming part of a wire separation tool, as described in the applicant's International Patent Application No. PCT/GB2008/050079, is located adjacent the camera 34, spaced therefrom by a distance x. This distance is factored in to the operation of the control means (not shown) as will be described in more detail below.

The tool head 24 is further provided with inner and outer wire bending tools 38, 39, respectively, located adjacent an exit orifice 37 for the separated insulated wire conductors 35 of the twisted pair cable 28. The operation of the inner and outer wire bending tools 38, 39 will also be described in more detail below.

A positioning camera 41 is also mounted on the tool head 24, offset to the right of the exit orifice 37. The positioning camera 41, under the operation of the control means (not shown) is adapted to identify the left hand edge, or other suitable reference datum, on the target IDC Block 22, 23. The control means then calculates the relatively small movement required to increment the tool head 24 to the target IDC connector slot (not shown in FIG. 2) as will be described in more detail below.

Referring now to FIG. 3, this shows the construction of the preferred embodiment of automated wiring apparatus 30 of the present invention in more detail. As can be seen, the tool head 24 is mounted for movement along the moveable track 26 via simple ball bearing rollers 42, with a like or similar arrangement (not visible in FIG. 3) also employed for mounting the moveable track 26 on the fixed track 25. The tracks 25, 26 themselves are formed from folded sections of sheet metal, shaped to receive the ball bearing rollers 42.

The tool head 24 is provided with a total of eight such ball bearing rollers 24, mounted on machined chassis members 43, 44, which are rigidly attached to the tool head 24. The axles of the ball bearing rollers 42 are inclined so that the rollers 42 bear normally on to the folded ‘V’ shape formed in the opposed rails of the moveable track 26. This arrangement constrains the tool head 24 so that its only degree of freedom is to roll in the horizontal (X) direction along the moveable track 26. Similarly, the only degree of freedom for the moveable track 26 is to move in the vertical (Y) direction along the fixed track 25. The chassis members 43, 44 are spring loaded relative to one another so that the ball bearing rollers 42 are spring-loaded onto their respective rails of the moveable track 26, thereby eliminating free play, which might otherwise be caused by tolerance errors in the assembly.

A toothed belt 45 driven by a motor 46 mounted at the end of the moveable track 26 provides the transmission for moving the tool head 24 along the moveable track 26. An encoder 47 is mounted on the tool head 24, and is adapted continuously to record the position of the tool head 24 relative to the origin of the moveable track 26. A broadly similar toothed belt transmission (not shown in FIG. 3) is employed to drive the moveable track 26 along the fixed track 25. A further motor 48, forming the drive means for the capstan 31, is also shown in FIG. 3.

Referring now to FIG. 4, there is shown the same apparatus 20 as described above with reference to FIG. 3, but viewed from the rear—that is, the side of the apparatus which in use faces the banks of IDC blocks 22, 23—and with certain components removed for clarity. The tool head position camera 41 is clearly visible in this view, as are the inner and outer wire bending tools 38, 39 respectively, and a servo 54 for operation thereof. Also shown in FIG. 4 is the wire insertion and extraction tool 49, the operation of which will be described in more detail below.

As can also be seen in FIG. 4, the wire manipulation tools of the tool head 24 are mounted on a rigid machined chassis 51 to which the chassis members 43, 44 carrying the bearing rollers 42 are fixed. The chassis 51 has two guide bars 52 rigidly mounted thereto, these guide bars 52 acting as a track for the wire insertion and extraction tool 49, enabling said tool 49 to translate through a short distance in the Z direction. Four trunnion bearings 53 mounted on the wire insertion and extraction tool 49 engage with the guide bars 52, to enable movement of said tool 49 along the guide bars 52.

Referring now to FIG. 5, this shows the tool head 24 as described above with reference to FIGS. 3 and 4, removed from the X and Y tracks 25, 26, for clarity. As can be seen from FIG. 5, a servo actuator 55 is fixed to the tool head chassis 51, said servo actuator being adapted to drive the motion of the wire insertion and extraction tool 49 in the Z direction. A second servo actuator 56 is fixed to the body 61 of the wire insertion and extraction tool 49 and is thus carried with said tool 49 during its motion in the Z direction. The second servo actuator 56 is adapted to operate gripper jaws 57, as will be described in more detail below. Also visible in FIG. 5 are a link 58 and bell crank 59 associated with the operation of the wire bending tools 38, 39, as will be described in more detail below.

Referring now to FIG. 6, this shows the tool head 24 with further components removed, including the chassis 51, for clarity. An actuator bearing and arm 62, normally hidden beneath servo actuator 55, is now visible, said actuator bearing and arm 62 being adapted to drive the motion of the wire insertion and extraction tool 49 in the Z direction when actuated by the servo 55. As can also be seen in FIG. 6, the wire insertion and extraction tool 49 is connected to the body 61 thereof via a thrust rod 63, which provides a flexibly resilient transmission to the wire insertion and extraction tool 49. This flexibility is necessary in order to absorb any impacts or interference between the wire insertion and extraction tool 49 and the IDC blocks 22, 23 during the insertion procedure. The required flexibility of the thrust rod 63 can be achieved by an assembly of rubber ‘O’ rings and metal washers sliding under compression on a rod, or by using a stack of Bellville washers, or a compression spring. As can also be seen in FIG. 6, the wire insertion and extraction tool 49 is mounted on a machined fixture 64 which in turn is mounted with respect to the body 61 by further trunnion bearings and shouldered pins, so as to allow motion of the wire insertion and extraction tool 49 in the Z direction, but to eliminate all other degrees of freedom.

The mechanism for operation of the inner and outer wire bending tools, 38, 39, respectively, is also more clearly visible in FIG. 6. The inner wire bending tool 38 is arranged to be actuated by servo 65 acting via link 58 and bell crank 59 and is shown in FIG. 6 in its normal rest position. As can be seen, the inner wire bending tool 38 has two grooves formed therein, adapted to collect and guide the separated insulated wire conductors 35 emerging from the exit orifice 37 of the tool head 24. The outer wire bending tool 39 is fixed directly to the arm of servo 54, and is also shown in FIG. 6 in its rest position. The outer wire bending tool 39 also has two grooves formed therein, adapted to collect and guide the separated insulated wire conductors 35 emerging from the exit orifice 37.

Referring now to FIG. 7, this shows the tool head 24 with still further components removed to reveal the mechanism for operation of the gripper jaws 57. The gripper jaw mechanism comprises first and second thrust plates 66 and 67 linked by a spring 68. The servo 56 has a lever and ball bearing follower (not shown) adapted to bear on the back edge of the second thrust plate 67 to produce movement in the Z direction. This is transmitted to the first thrust plate 66 via spring 68. The first thrust plate 66 is also restrained by a pre-loaded compression spring 69 which acts as a return spring. Spring 68 also acts to limit the maximum force in the linkage to about 80 N, though this may be adjusted.

Referring now to FIG. 8, this illustrates the action of the inner and outer wire bending tools 38, 39. The outer wire bending tool 39 is shown engaged with a pair of separated insulated wire conductor 35, acting to deflect them upwards towards the gripper jaws 57 and the wire insertion and extraction tool 49. The inner bend tool 38 has also moved upward by a small amount to provide additional restraint on the wires 35 as they emerge from the exit orifice 37. At this stage the gripper jaws 57 are open ready to receive the wires 35 when they are fully deflected upward.

Referring now to FIG. 9, this illustrates the separated insulated wire conductors 35 having been fully deflected upward by the outer wire bending tool 39, which is also shown in its maximum upward deflected position. The servo 56 now actuates the gripper jaws 57 via the action of the thrust plates 66, 67, the gripper jaws 57 acting to grasp the wires 35 firmly against insertion blades (not shown) on the wire insertion and extraction tool 49. The individual wires 35 are captured in slots (not visible in FIG. 9) formed in the wire insertion and extraction tool 49. The inner and outer wire bending tools 38, 39 now withdraw to their rest positions in preparation for the remainder of the wire insertion procedure, as will be described in more detail below.

Referring now to FIG. 10, this shows a view from below the tool head 24. The location of the line scan camera 34 can clearly be seen, as can the separator pin 36 and its actuator 71, which is arranged to be driven by a further servo 72 for the separator pin 36. Referring now to FIG. 11, this illustrates the tool head 24, in the process of inserting or removing a pair of separated insulated wire conductors 35 into a modified IDC block 22/23 as described in the applicant's International Patent Application No. PCT/GB2008/050136. As can be seen, the modified IDC block 22/23 is provided with guide means 73, and adapted to receive the tool head 24 in a nesting arrangement in order to facilitate the insertion of the wires 35 into selected adjacent connector slots 74 by the wire insertion and extraction tool 49, or the subsequent removal of the wires 35 therefrom.

The process of wiring a length of twisted pair cable 28 into first and second modified IDC blocks 22, 23 to form a jumper connection, utilising automated wiring apparatus 20 according to the present invention will now be described, with reference simultaneously to all of FIGS. 1 to 11.

The twisted pair cable 28 is fed into the tool head 24 by the feeding mechanism 30. As the cable 28 emerges from the feeding mechanism 30, the individual insulated wire conductors 35 are still twisted, and the wavelength of the twists may be variable due to the previous processing.

The line scan camera 34 scans the twisted cable 28 emerging from the feeding mechanism 30 in order to detect when the wires 35 present the required colour orientation (white/red or red/white) with the individual wires 35 lying side-by-side in a plane normal to the axis of the camera 34. Once the camera 34 identifies a suitable portion of cable 28, the feeding mechanism 30 is momentarily stopped and then incremented forward by a distance x corresponding to the distance between the camera 34 and the separator pin 36.

The separator pin 36 is actuated by its servo 72 and actuator 71, operated by the control means (not shown), so as to be urged between the individual insulated wire conductors 35 of the twisted pair cable 28. The cross-section of the wire transport channel (not shown) in the tool head 24 is changed locally to facilitate insertion of the pin 36 and to ensure reliable separation of the wires 35.

The feeding mechanism 30 then increments backward, pulling the twisted pair cable 28 back past the inserted separator pin 36 to produce a length of correctly oriented and separated insulated wire conductors 35 of sufficient length for the specified jumper connection. The separator pin 36 is then withdrawn, and the feeding mechanism 30 driven forward again until the separated wire conductors 35 emerge from the exit orifice 37 in the tool head 24.

The next stage of processing is to present the now separated and correctly oriented wires 35 to the wire insertion and extraction tool 49 that will carry out the insertion of the wires 35 into the IDC block 22. The inner wire bending tool 38 is now moved to engage with the pair of separated wires 35, locating each wire 35 in a groove formed on the bending tool 38, and guiding the wires 35 in an upward direction.

Immediately after this action, the outer wire bending tool 39 is actuated to bend the pair of wires 35 through approximately 90° so that they lie substantially vertically. The inner wire bending tool 38 then moves so as firmly to hold the wires 35.

A pair of gripper jaws 57 now grasp the separated wires 35 and clamp them against the insertion blades (not shown) of the wire insertion and extraction tool 49 in preparation for the insertion or extraction operation into the first modified IDC block 22. The inner and outer wire bending tools 38, 39 then swing back to their rest position.

The wire insertion and extraction tool 49 must now be accurately positioned relative to the selected pair of adjacent connector slots 74 in the first IDC block 22. The accuracy required for this operation is greater than can be achieved reliably by dead reckoning with the belt drive 45, 46 used to drive the tool head 24 along the moveable track 26, and the moveable track 26 along the fixed track 25.

The control means (not shown) now moves to locate the positioning camera 41 mounted on the tool head 24 so that it is aligned with a nominal reference position, being the left hand corner of the first IDC block 22. The camera 41 takes fresh XY bearings and communicates these to the control means, where the software carries out image processing to establish accurate XY co-ordinates for the reference position and the first end of the required jumper connection. The tool head 24 is then moved to position the wire insertion and extraction tool 49 at the co-ordinates corresponding to position of the first end of the required jumper connection. The wire insertion and extraction tool 49 is then aligned with the selected pair of adjacent connector slots 74 in the IDC block 22 and driven forward with sufficient force for the blade (not shown) in each connector slot 74 to displace the insulation on each wire 35 and make a secure connection. After insertion, the gripper jaws 57 open and the tool head 24 withdraws leaving the first end of the required jumper connection in place.

The control means then prepares to move the tool head 24 to connect the second end of the required jumper connection, on the second IDC block 23. In order to facilitate subsequent removal of the jumper connection it is essential that the twisted pair cable 28 is laid with the minimum density of packing in the horizontal gaps between the IDC blocks 22, 23, and the vertical gaps between the banks of IDC block 22, 23. To achieve this, the control means (not shown) must navigate an optimum path for the tool head 24 and the cable 28 must be fed by the feeding mechanism 30 at an optimum rate to avoid over-tensioning.

The control means (not shown) navigates the tool head 24 so as to locate the positioning camera 41 at a nominal reference position, being the left hand corner of the second IDC block 23. The image processing and calibration process is then repeated to calculate accurate XY co-ordinates for the selected pair of adjacent connector slots 74 on the second IDC block 23 constituting the second end of the required jumper connection. The tool head 24 is then moved to position the wire insertion and extraction tool 49 just above the selected pair of adjacent connector slots 74. The twisted pair cable 28 is then separated and orientated as before, with the length of separated individual wires 35 generated being sufficient to form both the second end of the present required jumper connection, and also the first end of the next required jumper connection.

The separated wires 35 are then fed, bent, gripped, and inserted into the selected connector slots 74 on the second IDC block 23, as previously described, to form the second end of the required jumper connection. The wire insertion and extraction tool 49 is then moved back clear of the connector block 23 leaving the pair of wires 35 in place.

The wires 35 are then cut immediately under the guide means 73 of the second IDC block 23 with a blade (not shown) provided on the tool head 24. The remaining wires 35 carried on the tool head 24 are then withdrawn back into the tool head 24 ready for formation of the first end of the next jumper connection. The wires 35 are held clear of the wire insertion and extraction tool 49, in case the next required operation is the removal of a redundant jumper connection.

The insertion procedure differs from the manual process in two important ways. Firstly, the two separated wires 35 of the twisted pair cable 28 are inserted into the IDC block 22/23 at the same time in one action without shorting the connectors. Secondly, the guide means 73 on the modified IDC block 22/23 present a short length of the wires 35 for grasping by the gripper jaws 57 in any subsequently required removal process. Each wire 35 is held in the IDC block 22/23 such that its only degree of freedom is in the negative Z direction, i.e. for removal from the IDC block 22/23. This negative Z motion is normally resisted by friction so that the wires 35 can only be removed by the application of force.

The removal of redundant jumper connections is carried out with a broadly similar sequence of steps. The control means locates the positioning camera 41 at the nominal reference position of the IDC block 22/23 carrying a first end of the connection, and carries out a position calibration as previously described. The wire insertion and extraction tool 49 is then moved to the location of the first end of the jumper connection and inserted into the IDC block 22/23. The gripper jaws 57 are then closed to grasp the pair of individual wires 35, which are held well spaced and vertical, between the connector slot 74 and the guide means 73. The tool 49 is then withdrawn thereby pulling the wires 35 free of the IDC block 22/23. The tool head 24 is then moved to a pre-determined position, clear of the parallel banks of IDC connector blocks 22, 23 and the gripper jaws are opened to release the wires 35.

The calibrating, positioning, gripping and extracting process is then repeated for the second end of the jumper connection on the other IDC block 22/23. After pulling the pair of wires 35 free of the IDC block 22/23 the tool head 24 moves to a pre-determined disposal position, clear of the banks of IDC blocks 22, 23, with the gripper jaws 57 still grasping the wires 35 from the last extracted connection. The wires 35 are then transferred to a wire disposal unit (not shown), which bails or chops the now scrap wire 35 and places the waste in a bin within the cabinet 21.

What is claimed is:

1. Automated wiring apparatus adapted for at least one operation selected from insertion of a length of wire into a selected connector on a connector block and extraction of a length of wire from a selected connector on a connector block, said apparatus comprising:
a tool head comprising at least one wire manipulation tools associated with effecting said at least one operation selected from insertion and extraction;
a supporting framework adapted for mounting adjacent a connector block;
positioning control means adapted to locate said tool head at any selected position on the supporting framework, each said selected position corresponding to a selected connector on the connector block; and
wiring control means adapted to actuate said at least one wire manipulation tool on said tool head, thereby to effect said at least one operation selected from insertion and extraction, as required.

2. The automated wiring apparatus of claim 1, in which:
the supporting framework defines an operational plane for the tool head, said operational plane having mutually perpendicular X and Y axes, and being disposed parallel to and spaced from said connector block when said framework is mounted adjacent thereto; and
the positioning control means is adapted to locate the tool head at any selected X,Y co-ordinates in said operational plane, each said selected X,Y co-ordinates corresponding to a selected connector on the connector block.

3. (canceled)

4. The automated wiring apparatus of claim 2, in which:
the supporting framework comprises a fixed track arranged parallel to one axis selected from the X axis and the Y axis of the operational plane, and a moveable track arranged parallel to the other axis selected from the X axis and the Y axis of the operational plane, said moveable track being mounted for movement along said fixed track; and
the tool head is mounted for movement along said moveable track.

5. The automated wiring apparatus of claim 4, in which:
the fixed track is arranged parallel to the Y axis of the operational plane;
the moveable track is arranged parallel to the X axis of the operational plane, and is mounted for movement along the fixed track, parallel to the Y axis of the operational plane; and
the tool head is mounted for movement along the moveable track, parallel to the X axis of the operational plane.

6. The automated wiring apparatus of claim 2, in which the positioning control means comprise at least one position sensors provided on the tool head and adapted to determine said tool head's location in the operational plane, with reference to X and Y co-ordinates corresponding to individual connectors on said connector block, and tool head drive means adapted to drive said tool head to a selected location in the operational plane.

7. (canceled)

8. (canceled)

9. The automated wiring apparatus of claim 2, in which said at least one wire manipulation tool provided on the tool head includes at least one tool selected from:
a wire insertion and extraction tool, adapted to effect insertion and extraction of the wire in a direction parallel to a Z axis, being perpendicular to each of said X and Y axes and the operational plane of the tool head;
at least one wire bending tool adapted to bend each said wire into a vertical orientation in preparation for insertion into a selected connector;
a wire gripping tool adapted to grip each wire in preparation for, and during, insertion into a selected connector, and subsequent extraction therefrom;
an insertion blade adapted for forced insertion of each wire into a selected connector; and
a cutting mechanism to cut excess wire subsequent to insertion of each wire into its selected connector.

10. (canceled)

11. (canceled)

12. (canceled)

13. (canceled)

14. (canceled)

15. (canceled)

16. (canceled)

17. The automated wiring apparatus of claim 1, adapted for insertion and extraction of separated individual insulated wire conductors of a length of twisted pair cable into selected adjacent connectors on an insulation displacement connector block, and in which said at least one wire manipulation tool provided on the tool head includes a wire separation tool for separating a length of twisted pair cable into its constituent individual insulated wire conductors, said wire separation tool comprising:
a separator adapted for insertion between said individual insulated wire conductors constituting the twisted pair cable; and
cable drive means adapted to displace said length of twisted pair cable relative to the inserted separator in a direction co-incident with the axis of the twisted pair cable, thereby causing plastic deformation of the individual insulated wire conductors so as to form a length of cable comprising a pair of substantially parallel separated individual insulated wire conductors.

18. The automated wiring apparatus of claim 17, in which the tool head further comprises sensor adapted to detect colour orientation of said individual insulated wire conductors adjacent the separator.

19. (canceled)

20. The automated wiring apparatus of claim 17, adapted to effect at least one operation selected from:
insertion of both separated individual insulated wire conductors of a length of twisted pair cable into adjacent connectors on an insulation displacement connector block, in a single operation; and
extraction of both separated individual insulated wire conductors of a length of twisted pair cable from adjacent connectors on an insulation displacement connector block, in a single operation.

21. (canceled)

22. The automated wiring apparatus of claim 17, adapted for insertion and extraction of separated individual insulated wire conductors of a length of twisted pair cable into selected adjacent connectors on a modified insulation displacement connector block having an array of insulation displacement connectors adapted to receive an insulated wire conductor, and guide means spaced relative to said connector array so as to define a gap therebetween, said guide means being adapted for aligning each said wire conductor with a selected connector, and further adapted to receive a length of each said wire conductor extending from its selected connector to a corresponding location on said guide means, such that said length of insulated wire conductor bridges said gap.

23. (canceled)

24. The automated wiring apparatus of claim 17, further comprising a modified insulation displacement connector block having an array of insulation displacement connectors adapted to receive an insulated wire conductor, and guide means spaced relative to said connector array so as to define a gap therebetween, said guide means being adapted for aligning each said wire conductor with a selected connector, and further adapted to receive a length of each said wire conductor extending from its selected connector to a corresponding location on said guide means, such that said length of insulated wire conductor bridges said gap.

25. (canceled)

26. The automated wiring apparatus of claim 17, further comprising a feeding mechanism adapted for feeding a length of twisted pair cable to the tool head, said feeding mechanism, comprising:
a capstan having a substantially circular periphery;
a continuous belt supported so that a portion thereof embraces an arc of the capstan periphery;
a path adapted to receive a length of twisted pair cable, said path being defined between said capstan and said continuous belt; and
drive means for effecting rotation of said capstan;
and wherein in use said path accommodates at least two nodes of said length of twisted pair cable therein, such that rotation of said capstan drives said length of twisted pair cable along said path, without causing rotation of said twisted pair cable about its axis.

27. The automated wiring apparatus of claim 26, further comprising a replaceable reel of wire mounted within said apparatus, said feeding mechanism being adapted to draw wire from said replaceable reel.

28. (canceled)

29. (canceled)

30. An automated wiring method for insertion of a length of wire into a selected connector on a connector block, said method comprising:
positioning a wiring tool head at a selected location on a supporting framework mounted adjacent a connector block, said selected location corresponding to a selected connector on said connector block; and
actuating the wiring tool head so as to effect insertion of a portion of a wire into said selected connector.

31. The automated wiring method of claim 30, comprising positioning said tool head at a pair of selected X,Y co-ordinates in an operational plane defined by said supporting framework, said operational plane being parallel to and spaced from said connector block, and each said pair of X,Y co-ordinates corresponding to a selected connector on said connector block.

32. The automated wiring method of claim 31, in which:
said length of wire is a length of twisted pair cable, separated into a pair of substantially parallel individual insulated wire conductors; and
said wiring tool head is positioned and actuated so as to effect insertion of a portion of said separated parallel conductors into a selected pair of adjacent connectors on the connector block.

33. The automated wiring method of claim 32, for effecting a jumper connection between a first selected pair of adjacent connectors located on a first connector block, and a second selected pair of adjacent connectors located on a second parallel connector block, said method comprising:
positioning a wiring tool head at a first pair of selected X,Y co-ordinates in an operational plane parallel to and spaced from first and second connector blocks arranged parallel to one another, said first pair of X,Y co-ordinates corresponding to a first selected pair of adjacent connectors on said first connector block;
actuating said wiring tool head so as to effect insertion of a first portion of said separated parallel conductors into said first selected pair of adjacent connectors;
positioning said wiring tool head at a second pair of selected X,Y co-ordinates in said operational plane, said second pair of selected X,Y co-ordinates corresponding to a second selected pair of adjacent connectors on said second connector block; and
actuating said wiring tool head so as to effect insertion of a second portion of said separated parallel conductors into said second selected pair of adjacent connectors.

34. (canceled)

35. (canceled)

36. The automated wiring method of claim 30, further comprising at least one selected from:
feeding a length of wire to said wiring tool head;
bending each said portion of wire into a vertical orientation in preparation for insertion into its selected connector;
gripping each said portion of wire in preparation for, and during, insertion into its selected connector; and
cutting excess wire subsequent to insertion of each wire into its selected connector.

37. The automated wiring method of claim 30, further comprising a step of extracting a previously inserted wire from a selected connector.

38. The automated wiring method of claim 30, for insertion of a length of separated twisted pair cable into a selected pair of adjacent connectors on a connector block, further comprising at least one of separating said length of twisted pair cable into its constituent individual insulated wire conductors.

39. (canceled)

40. (canceled)
